(19) United States
(12) Patent Application Publication
(10) Pub. No.: US 2018/0173455 A1
(43) Pub. Date: Jun. 21, 2018

(54) STORAGE PROFILER FOR A COMPUTER OPERATING SYSTEM

(71) Applicant: INTERNATIONAL BUSINESS MACHINES CORPORATION, ARMONK, NY (US)

(72) Inventors: FRANCISCO M. ANAYA, HOLLISTER, CA (US); RANDALL T. CAMPBELL, APEX, NC (US); SEANA K. HOGAN, VALLEY SPRINGS, CA (US); TRONG TRUONG, ONTARIO (CA)

(21) Appl. No.: 15/381,190

(22) Filed: Dec. 16, 2016

(51) Int. Cl. G06F 3/06

(52) U.S. Cl. CPC G06F 3/0653; G06F 3/0673; G06F 3/0604

(57) ABSTRACT

Embodiments include a technique for operating a storage profiler for a computer operating system. The technique includes analyzing statements of an application to identify instructions that are associated with obtaining storage and statements that alter storage values in the obtained storage upon entry to every compile unit in the application, and overlaying storage statement hooks on the identified instructions and the identified statements. The technique also includes responsive to overlaying the storage statement hooks, updating a storage data structure based on the storage statement hooks, displaying the storage usage data as a grid map based on the storage data structure, the grid map comprising blocks associated with a storage location for system memory, and selecting a data block of the grid map for the storage usage data.

### BACKGROUND

The present invention relates to memory usage information, and more specifically, to a storage profiler for a computer operating system.

In today's environment there many tools on the market that monitor application memory usage. Storage utilization is a quantitative measure of how well the available data storage space in an enterprise is used. Many of the tools monitor real-time storage usage or are concerned with end-to-end performance metrics such as CPU utilization. Other tools can track the utilization of external memory. As the number of utilized applications increase and the amount of data to be stored increases, storage utilization must be efficiently managed given a set of limited resources. The information gathered regarding storage usage can be used by programmers during a design process to optimize the operation of a program. Understanding storage usage within an application is important for defect detection, performance evaluation, and application efficiency.

### SUMMARY

According to an embodiment of the present invention, computer-implemented methods, systems, and computer program products for storage profiler for a computer operating system.

An embodiment includes a computer-implemented method for operating a storage profiler for a computer operating system. The method includes analyzing statements of an application to identify instructions that are associated with obtaining storage and statements that alter storage values in the obtained storage upon entry to every compile unit in the application, and overlaying storage statement hooks on the identified instructions and the identified statements. The method also includes responsive to overlaying the storage statement hooks, updating a storage data structure based on the storage statement hooks, displaying the storage usage data as a grid map based on the storage data structure, the grid map comprising blocks associated with a storage location for system memory, and selecting a data block of the grid map for the storage usage data.

Another embodiment includes a computer program product for operating a storage profiler for a computer operating system, the computer program product having a computer readable storage medium having stored thereon first program instructions executable by a processor to cause the processor to analyze statements of an application to identify instructions that are associated with obtaining storage and statements that alter storage values in the obtained storage upon entry to every compile unit in the application. The instructions are further executable to cause the processor to overlay storage statement hooks on the identified instructions and the identified statements, and responsive to overlaying the storage statement hooks, update a storage data structure based on the storage statement hooks. The instructions are also executable to cause the process to display the storage usage data as a grid map based on the storage data structure, the grid map comprising blocks associated with a storage location for system memory; and select a data block of the grid map for the storage usage data.

A different embodiment includes system for a storage profiler for a computer operating system, the system includes a system memory, a storage medium, the storage medium being coupled to a processor, the processor configured to analyze statements of an application to identify instructions that are associated with obtaining storage and statements that alter storage values in the obtained storage upon entry to every compile unit in the application. The processor is also configured to overlay storage statement hooks on the identified instructions and the identified statements and responsive to overlaying the storage statement hooks, update a storage data structure based on the storage statement hooks. The processor is configured to display the storage usage data as a grid map based on the storage data structure, the grid map comprising blocks associated with a storage location for system memory, and select a data block of the grid map for the storage usage data.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 is a flow diagram illustrating a method for storage profiler for a computer operating system in accordance with an embodiment;

FIG. 3 is grid map for a storage profiler for a computer operating system in accordance with another embodiment;

FIG. 4 is grid map for a storage profiler for a computer operating system in accordance with another embodiment;

FIG. 5 is grid map for a storage profiler for a computer operating system in accordance with an embodiment; and

FIG. 6 is grid map for a storage profiler for a computer operating system in accordance with an embodiment.

### DETAILED DESCRIPTION

In accordance with exemplary embodiments of the disclosure, methods, systems and computer program products for storage profiler for a computer operating system, such as z/OS™.

The technique provided herein detects storage inefficiencies where storage is obtained and not used. For example, the scenario may exist where large macros are included in an application where storage is obtained for the large macros, but only a small fraction of the obtained storage is actually used.

In addition, this technique allows for locating the source of errors using program slicing at the storage address level. Program slicing at the storage address level effectively shows program inefficiencies in storage usage. Also, the described technique identifies the source of storage overlays in an application. A comprehensive view of application storage for a computer operating system is provided which includes information of the obtained and freed storage as well as showing usage of the specific storage blocks of the system memory.

Monitoring variable value changes as an application executes is a useful debugging mechanism, but requires the programmer to set break points to watch the variable changes within an application. This requires the programmers to know in advance which CUs alter a particular storage in order to set breakpoints to monitor that storage. Often a storage alteration trap to capture a dump must be set; this requires privileged system access and the knowledge of the specific address or register and offset, and a time-consuming dump analysis to determine the culprit in cases of storage corruption.

Data associated with the memory allocation and utilization of the system memory is collected and displayed in a graphical heat map where storage usage can be visualized. A list of all compile units that have accessed a particular block of storage can be listed, the variable names used by the individual CUs, and the length and value of storage accessed can be graphically displayed. The disclosure herein provides a technique to gather storage usage data and provides a way to visualize the storage usage in a computer operating system application program.

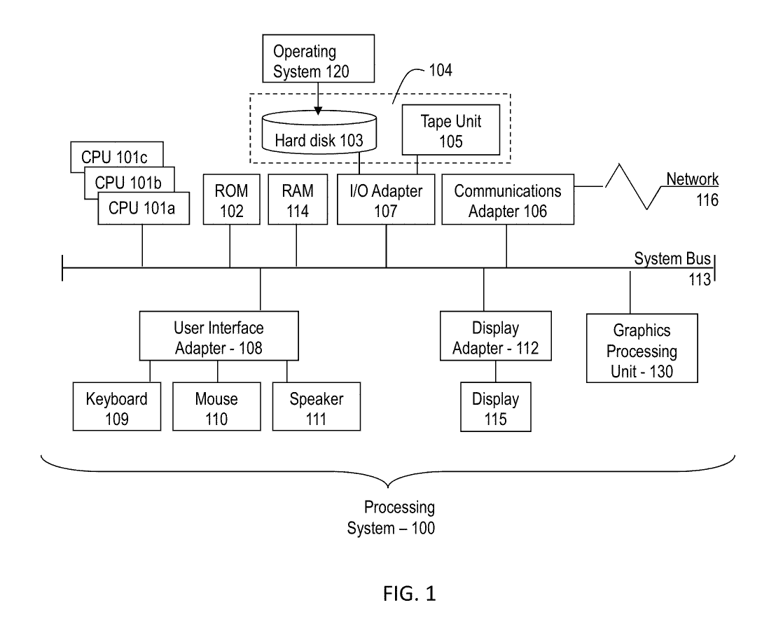

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

In an embodiment, an application is launched under the control of a capable application such as a debugger that specifies a new preference indicating storage instrumentation. During processing the code of a selected application will be analyzed by a processor and storage instrumentation processing will overlay hooks on instructions associated with obtaining storage and will also overlay hooks on instructions associated with all statements that alter storage values in the obtained storage upon entry to every compile unit (CU) in the application.

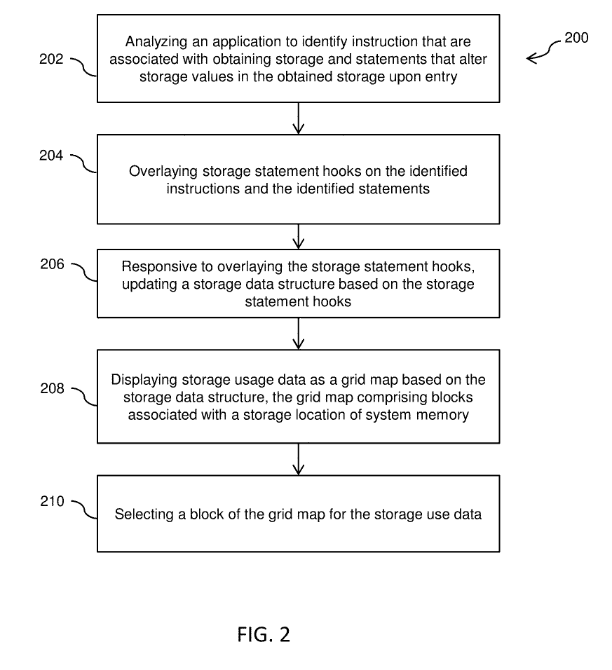

Referring now to FIG. 2, a method 200 for operating a storage profiler for a computer operating system is shown. Block 202 includes analyzing an application to identify instructions that are associated with obtaining storage and statements that later storage values in the obtained storage upon entry to each compile unit CU in the application.

Block 204 provides overlaying statements hooks on the identified instructions and the identified statements. In an embodiment, storage instrumentation processing will overlay hooks on instructions associated with obtaining storage and overlay hooks on instructions associated with all statements that alter storage values in the obtained storage. These hooks are referred to as storage statement hooks.

Block 206 provides responsive to overlaying the storage statement hooks, updating a storage data structure. In one or more embodiments, storage statement hooks are provided for instructions and statements that obtain storage, alter storage, and/or release storage.

In another embodiment, for each storage statement hook on instructions that obtain storage, a node is added to a new storage data structure. In a different embodiment, for each storage statement hook on instructions that alter storage, the node associated with the location of the variable is found in an existing storage data structure. Information including the CU-name, variable name, the address, the length, the value and the statement number within the CU of the variable are stored in the node of the storage data structure. In a different embodiment, for each storage statement hook on instructions that release storage, the storage data structure node associated with the block is searched. Once found the data within the node is translated to a formatted script that is consumable by a user interface (UI). The script data is cumulatively saved to a repository and processed by a processor and UI for displaying the collected information.

Block 208 provides displaying storage usage data as a grid map based on the storage data structure, the grid map comprises blocks associated with a storage location. In one or more embodiments, a graphical heat map is used to convey storage usage information at the address level. In one or more embodiments, upon completion of the execution of the application and the information is collected for each storage data structure and nodes, and the storage usage information is translated into a grid map.

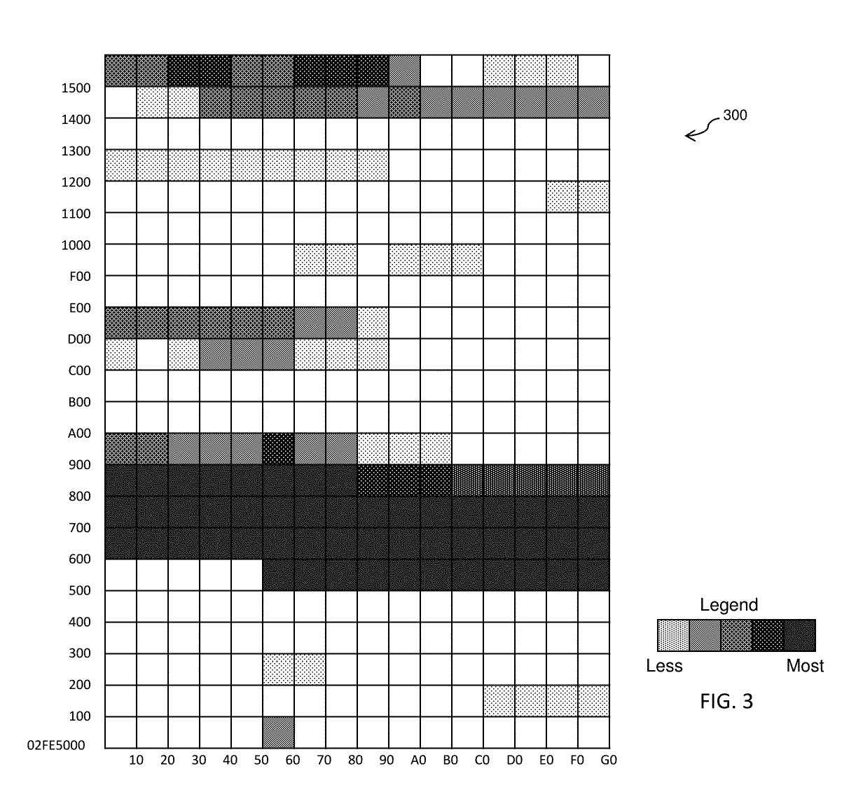

Block 210 provides selecting a block of the grid map for the storage use data. In one or more embodiments, a user can select a block on the grid map to obtain additional information. As will be shown in FIGS. 3, 4, 5, and 6 users can select a storage block of the grid map to get more storage usage information related to the data stored in that location. For example, a user can select a CU that has affected the storage block and continuously drill down to obtain bit level information with respect to the variables of the CU.

Now referring to FIG. 3, a grid map 300 for a storage profiler for a computer operating system in accordance with an embodiment is shown. The grid map 300 is comprised of a plurality of blocks representing a storage location of data. Also in one or more embodiments, the storage location is for system memory. In one or more embodiments, the address level information identifies an address for a location in system memory.

In another embodiment, grid map 300 is a heat map which provides a visual representation of the obtained and freed storage used by an application. For each memory block, as the number of compile units of an application that uses data stored in a system memory location represented by a storage block increases, the associated block becomes darker. For example, as provided by the legend, a darker block has been accessed a greater number of times when compared to the other memory blocks. The heat map provides a comprehensive view showing the usage of specific storage blocks for the application during the execution of the application.

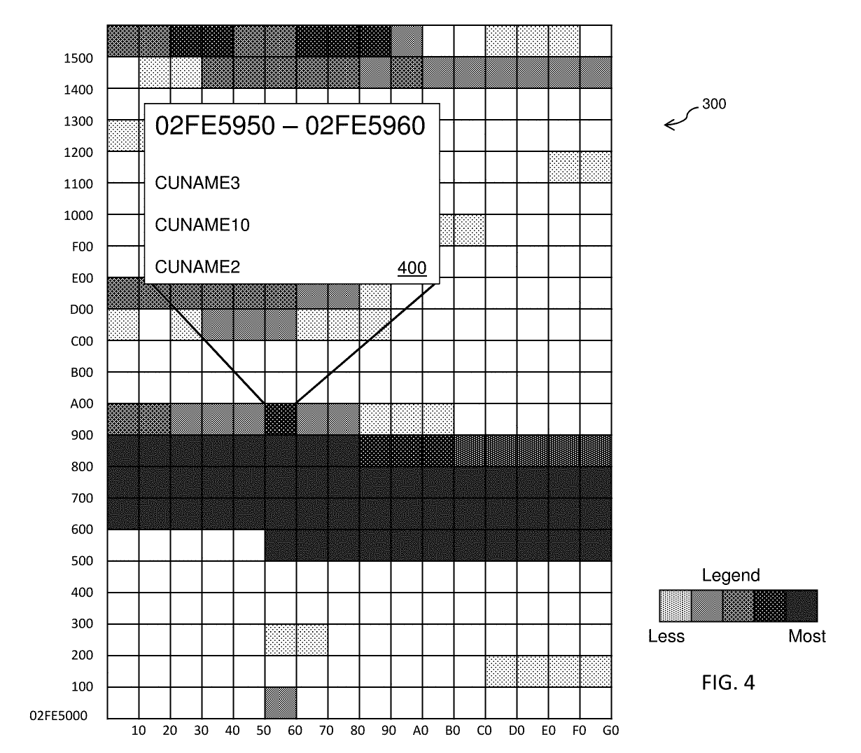

FIG. 4 illustrates the grid map 300 in accordance with an embodiment. In an embodiment, a user has selected a memory block of the grid and information associated with that memory can be displayed in an information block. The address range for the selected memory block is shown. In this example, the selected block represents system memory location 02FE5950-02FE5960. Information block 400 also provides CU name information for those CUs of the application that have accessed the data in the memory block. Each CU that has altered the data of the memory block is listed in the information block 400. In this example, CUNAME3, CUNAME10, and CUNAME2 of the application has accessed the selected memory block.

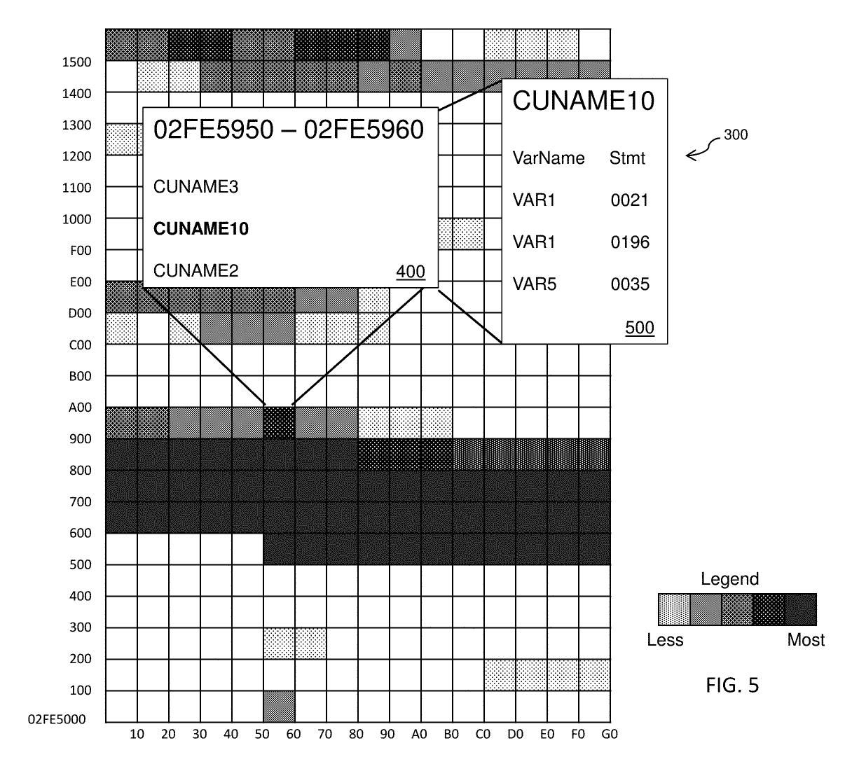

Now referring to FIG. 5, grid map 300 for storage profiler for a computer operating system in accordance with an embodiment is shown. Grid map 300 provides for each identified CU, variable name information (VarName) for each variable of the identified CU and the statement number (Stmt) the variable appears within the CU. For example, if a user selects CUNAME10, information block 500 provides VarName as VAR1 appearing in statement Stmt 0021 and 0196. Information block 500 also displays VAR5 of CUNAME10 appearing at Stmt 0035.

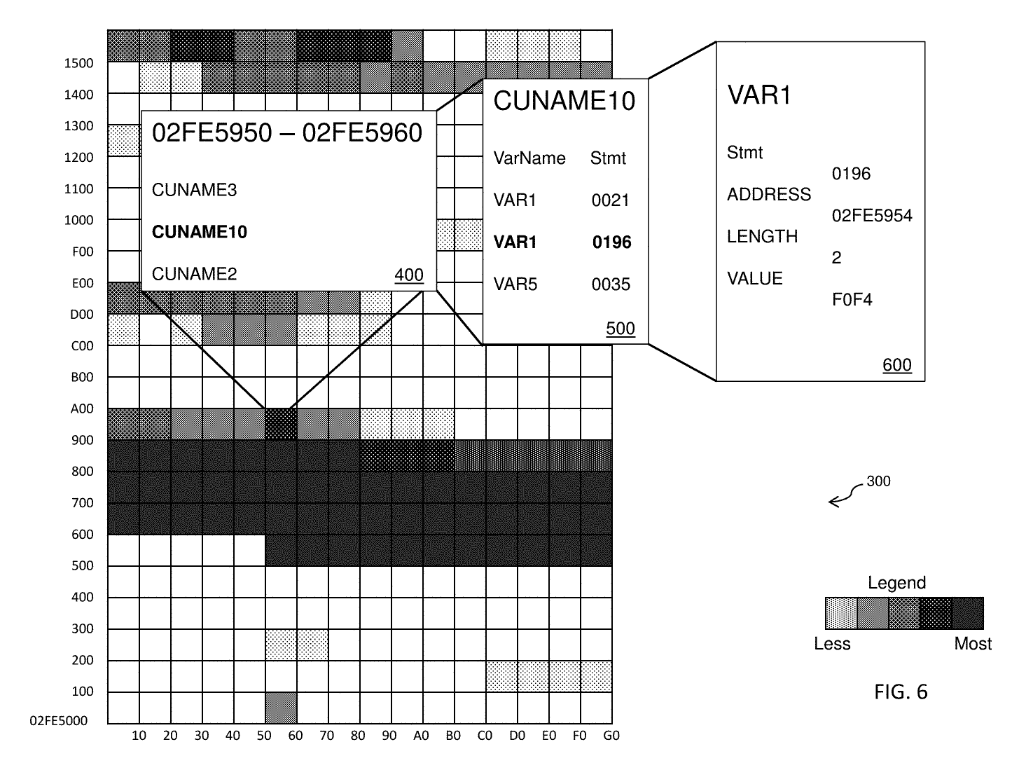

Now referring to FIG. 6 grid map 300 for a storage profiler for a computer operating system in accordance with an embodiment is shown. In one or more embodiments, additional information can be displayed for each VarName appearing in a CU. A user can select a VarName. In this example, FIG. 6 illustrates VAR1 has been selected from information block 500. Information block 600 provides for each variable, statement number information, variable address information, variable length, and the value of the variable. For each VarName appearing in the 500 each piece of information has been determined. Block 600 for VAR1 the Stmt is 0196, the variable address is 02FE5954, the variable length is 2 bytes, and the variable value is F0F4. The information provided by this technique has been collected for each memory block.

The technique described herein provides a granular analysis of each storage location. This technique allows programmers and debuggers to identify inefficiencies in storage processing of an application. Using the gathered information programmers can optimize the programs by altering the code to ensure that programs only reserve as much memory as the program will use.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for operating a storage profiler for a computer operating system, the computer-implemented method comprising:
analyzing statements of an application to identify instructions that are associated with obtaining storage and statements that alter storage values in the obtained storage;
overlaying storage statement hooks on the identified instructions and the identified statements;
responsive to overlaying the storage statement hooks, updating a storage data structure based on the storage statement hooks;
displaying a storage usage data as a grid map based on the storage data structure, the grid map comprising blocks associated with a storage location for system memory; and
selecting a data block of the grid map for the storage usage data.

2. The computer-implemented method of claim 1, wherein the updating the storage data structure comprises adding a storage data structure node for each instruction that obtains storage.

3. The computer-implemented method of claim 1, wherein the updating the storage data structure comprises locating a variable associated with instructions that alter storage, and responsive to locating the variable, storing a compile unit name, variable name, a variable address, a variable length, value of the variable, and a statement number of the variable within a respective compile unit.

4. The computer-implemented method of claim 1, wherein the updating the storage data structure comprises locating a node associated with a block of storage for each instruction that releases storage.

5. The computer-implemented method of claim 1, wherein the selection comprises selecting a block of the grid map for displaying compile unit information that has altered data stored in the selected block.

6. The computer-implemented method of claim 5, wherein the selection comprises selecting a compile unit for displaying each variable and associated statement numbers within the storage that were used to alter data.

7. The computer-implemented method of claim 6, wherein the selection comprises selecting a variable for displaying the variable statement number within the compile unit, variable address information within the storage block, length and value associated with the variable.

8. A computer program product for a storage profiler for z/OS, the computer program product comprising:
a computer readable storage medium having stored thereon first program instructions executable by a processor to cause the processor to:
analyze statements of an application to identify instructions that are associated with obtaining storage and statements that alter storage values in the obtained storage upon entry;
overlay storage statement hooks on the identified instructions and the identified statements;
responsive to overlaying the storage statement hooks, update a storage data structure based on the storage statement hooks;
display a storage usage data as a grid map based on the storage data structure, the grid map comprising blocks associated with a storage location for system memory; and
select a data block of the grid map for the storage usage data.

9. The computer program product of claim 8, wherein the updating the storage data structure comprises adding a storage data structure node for each instruction that obtains storage.

10. The computer program product of claim 8, wherein the updating the storage data structure comprises locating a variable associated with instructions that alter storage, and responsive to locating the variable, storing a compile unit name, variable name, a variable address, a variable length, value of the variable, and a statement number of the variable within a respective compile unit.

11. The computer program product of claim 8, wherein the updating the storage data structure comprises locating a node associated with a block of storage for each instruction that releases storage.

12. The computer program product of claim 8, wherein the selection comprises selecting a block of the grid map for displaying compile unit information that has altered that data.

13. The computer program product of claim 12, wherein the selection comprises selecting a compile unit for displaying each variable and associated statement numbers within the storage that were used to alter data.

14. The computer program product of claim 13, wherein the selection comprises selecting a variable for displaying the variable statement number within the compile unit, variable address information within the storage block, length and value associated with the variable.

15. A system for a storage profiler for a computer operating system, the system comprising:
a system memory;
a storage medium, the storage medium being coupled to a processor;
the processor configured to:
analyze statements of an application to identify instructions that are associated with obtaining storage and statements that alter storage values in the obtained storage upon entry;
overlay storage statement hooks on the identified instructions and the identified statements;
responsive to overlaying the storage statement hooks, update a storage data structure based on the storage statement hooks;
display a storage usage data as a grid map based on the storage data structure, the grid map comprising blocks associated with a storage location for system memory; and
select a data block of the grid map for the storage usage data.

16. The system of claim 15, wherein the updating the storage data structure comprises adding a storage data structure node for each instruction that obtains storage.

17. The system of claim 15, wherein the updating the storage data structure comprises locating a variable associated with instructions that alter storage, and responsive to locating the variable, storing a compile unit name, variable name, a variable address, a variable length, value of the variable, and a statement number of the variable within a respective compile unit.

18. The system of claim 15, wherein the updating the storage data structure comprises locating a node associated with a block of storage for each instruction that releases storage.

19. The system of claim 15, wherein the selection comprises selecting a block of the grid map for displaying compile unit information that has altered data.

20. The system of claim 19, wherein the selection comprises selecting a compile unit for each variable and associated statement numbers within the storage that were used to alter the data and wherein the selection comprises selecting a variable for the variable statement number within the compile unit, variable address information within the storage block, length and value associated with the variable.
